(19) United States
(12) Patent Application Publication
(10) Pub. No.: US 2018/0196584 A1
(43) Pub. Date: Jul. 12, 2018

(54) EXECUTION OF MULTIPLE APPLICATIONS ON A DEVICE

(71) Applicant: Alibaba Group Holding Limited, George Town (KY)

(72) Inventors: Jinglu Han, Hangzhou (CN); Yongsheng Zhu, Hangzhou (CN); Ping Dong, Hangzhou (CN); Jingfu Ye, Hangzhou (CN); Jianming Lai, Hangzhou (CN); Zhijun Yuan, Hangzhou (CN); Xinhua Yu, Hangzhou (CN)

(21) Appl. No.: 15/862,384

(22) Filed: Jan. 4, 2018

(30) Foreign Application Priority Data
Jan. 9, 2017 (CN) 201710015068.0

(51) Int. Cl. G06F 3/0484; H04M 1/725; G06F 3/0481; G06F 9/54; G06F 17/30

(52) U.S. Cl. CPC G06F 3/04842; H04M 1/72583; G06F 17/30985; G06F 9/543; G06F 3/0481

(57) ABSTRACT

Executing multiple applications includes: executing a first application; using the first application to trigger a second application located; transferring data from the second application to the first application; and presenting the data that is transferred from the second application in a visualization area within a user interface display area of the first application.

### CROSS REFERENCE TO OTHER APPLICATIONS

This application claims priority to People's Republic of China Patent Application No. 201710015068.0 entitled A METHOD AND A MEANS FOR RUNNING APPS, filed Jan. 9, 2017 which is incorporated herein by reference for all purposes.

### FIELD OF THE INVENTION

The present application relates to a field of computer technology. In particular, it relates to a method and a means for running applications (also referred to as apps).

### BACKGROUND OF THE INVENTION

With the rapid development of mobile telecommunication technology and the arrival of the mobile multimedia age, the mobile phone has evolved from a simple telecommunication tool to a sophisticated computing device with many functions. It has evolved into a mobile platform for collecting and processing personal information. Various operating systems and a wide array of application software are available on smart phones.

Existing mobile operating systems typically adhere to the desktop operating system model, where a user is usually required to locate an application, then select and launch the application to obtain desired information. For example, the user typically needs to select and launch a weather application in order to obtain weather information, select and launch a health application in order to monitor activity level information, etc. The requirement for multiple operations to access information is cumbersome for the user and affects the usability of the device. Further, because up-to-date information is not easily available to the user, the full capabilities of the device are not efficiently utilized.

### BRIEF DESCRIPTION OF THE DRAWINGS

Various embodiments of the invention are disclosed in the following detailed description and the accompanying drawings.

In order to provide a clearer explanation of the technical schemes in embodiments of the present application, simple introductions are given below to the drawings that are needed for the embodiments. Obviously, the drawings described below are merely some embodiments of the present application. Persons with ordinary skill in the art could, without expending creative effort, obtain other drawings on the basis of these drawings.

FIG. 1 is a diagram of information transfer between Pages in an embodiment of the present application.

FIG. 2 is a diagram of a visualization area in a UI of a first app in an embodiment of the present application.

FIG. 3 is a flowchart of app triggering in an embodiment of the present application.

FIG. 4 is a diagram of the card mode in an embodiment of the present application.

FIG. 5 is a diagram of the Widget mode in an embodiment of the present application.

FIG. 6 is a diagram of the super Widget mode in an embodiment of the present application.

FIG. 7 is a diagram of a second app life cycle in an embodiment of the present application.

FIG. 8 is a structural diagram of an app running means provided by an embodiment of the present application.

FIG. 9 is a structural diagram of an app running means provided by another embodiment of the present application.

FIG. 10 is a structural diagram of a communication device provided by an embodiment of the present application.

FIG. 11 is a functional diagram illustrating a programmed computer system for displaying app information in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Although the concepts of the present application may easily undergo various modifications and substitutions, its specific embodiments have already been shown through the examples in the drawings and in the detailed descriptions in this document. However, please note that there is no intention of limiting the concepts of the present application to the disclosed specific forms. On the contrary, the intention is to cover all modifications, equivalents, and substitutions consistent with the present application and the attached claims.

In citing “an embodiment,” “the embodiments,” “an illustrative embodiment,” etc., the Description is indicating that the described embodiment may include specific features, structures, or characteristics. However, each embodiment may or may not include particular features, structures, or characteristics. In addition, such phrases do not necessarily refer to the same embodiments. Furthermore, it is believed that, when the features, structures, or characteristics are described in light of embodiments, such features, structures, or characteristics are affected through their combination with other embodiments (whether they are described clearly) within the scope of knowledge of persons skilled in the art. In addition, the items included in a list taking the form of “at least one of A, B and C” may be expressed as: (A), (B), (C), (A and B), (A and C), (B and C), or (A, B and C). Similarly, items listed in the form of “at least one of A, B or C” may be expressed as: (A), (B), (C), (A and B), (A and C), (B and C), or (A, B and C).

In some cases, the disclosed embodiment may be implemented as hardware, firmware, software, or any combination thereof. The disclosed embodiment may also be implemented as instructions that are carried or stored in one or more temporary or non-temporary machine-readable (e.g., computer-readable) storage media that can be read and executed by one or more processors. Machine-readable storage media may be embodied as any storage devices, mechanisms, or other devices with physical structures used to store or transmit information in machine-readable form (such as volatile or non-volatile memory, media disks, or other media).

In the drawings, some structures or method features may be shown in specific layouts and/or sequences. However, please understand that these specific layouts and/or sequences may be unnecessary. On the contrary, in some embodiments, these features may be laid out in ways and/or sequences that differ from what is shown in the illustrative drawings. In addition, the fact that a particular drawing includes structure or method features does not imply that such features are necessary in all embodiments. Moreover, in some embodiments, they may not be included, or they may be combined with other features.

“Apps” described herein may be understood as applications or programs capable of implementing certain functions. Specifically, they comprise application program code, resources, metadata, and/or other appropriate components. The application programs may include system applications, downloadable and installable applications (such as third party applications), foreground programs (e.g., programs that allow direct user interaction with the device through user interfaces, such as messaging or video chat programs), or background services (e.g., programs that do not provide user interfaces, such as programs for updating downloads). Components refer to packages of data and methods such as reference data, libraries, etc. An application program is generally composed of many components. The various components work together and jointly form the functions of a complete application program. In other words, components refer to execution units that have a smaller granularity than applications.

In embodiments of the present application, to give the user an intuitive grasp of the app content or to enable him or her to use the services provided by the app more easily, the app is provided with the ability to display an outline of its contents by cooperating with other apps. For example, App A may trigger App B by making certain API or function call and cause App B to execute, obtaining desired information from App B, and presenting information obtained from App B (such as App B data) in the user interface (UI) of App A. To facilitate description in embodiments of the present application, the app that is used to trigger the other app is called the first app, and the other app (such as App B in the example above) that can be triggered by the first app is correspondingly called the second app.

The first app can trigger the second app under many kinds of situations. For example, the second app may not be running yet (i.e., there still is no instance of the second app), or one or more instances of the second app may have already been created. When the first app calls the second app to present information from the second app, if no instance of the second app has been created yet, the system will create an instance of the second app in response and execute this instance. If a second app instance has already been created, then the first app triggers the second app by interacting with the second app instance to acquire data from the second app. As used herein, an instance of an app refers to the object or process that is being executed. The first app may also create additional instance(s) of the second app and acquire second app data by interacting with the additional instance(s).

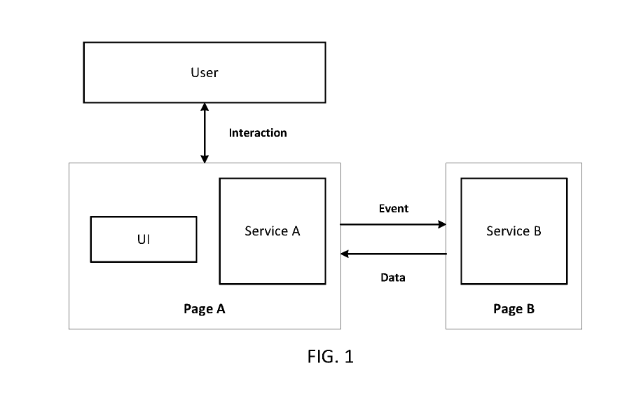

Embodiments of the present application may be used in many kinds of operating systems—in a mobile operating system, for example, and particularly in a cloud operating environment (e.g., YunOS™ or other operating systems designed to operate within cloud computing and visualization environments). In a cloud operating environment, a “Page” refers to a service component. It is an organization of local service and remote service, i.e., the basic unit of app service. By packaging data and methods, a Page can provide various kinds of services. A running Page is called a Page instance. It is a running container for a local service or a remote service. It can be created, scheduled, or managed by a cloud-based manager such as the Dynamic Page Manager Service (DPMS). (For example, after receiving a PageLink to Page B sent by Page A, DPMS can create an instance of Page B.) DPMS can maintain the life cycle of the Page instance. A Page is uniquely identified on a cloud operating system. For example, a Page can be identified using a Uniform Resource Identifier (URI). Different pages may belong to the same domain, or they may belong to different domains. Events and/or data can be transmitted between Pages. A Page can interact with a user via a user interface (UI) to provide service. As shown in FIG. 1, Page A and Page B are two different Pages. Page A is configured to provide Service A, and Page B is configured to provide Service B. Page A can also provide a user with a user interface in the form of a UI, present a service to the user through this user interface, and receive various kinds of input from the user. Page B can mainly run in the background and provide service support for other Pages. Page A can send an event to Page B and acquire data sent back from Page B. Page A can interact with a user via a UI. In this example, both Page A and Page B execute on the same device (e.g., a smartphone or other client device.) In other embodiments, Pages A and B execute on separate devices (e.g., Page A on a client device, Page B on a server). The locations of the pages are flexible so long as Page A is able to access Page B and obtain data.

Embodiments of the present application can also be applied to non-cloud operating systems. In such cases, the first app and the second app can be non-cloud operating system apps that conform to app specifications. An example would be the Activity app in an Android™ system.

The first app can interact with a user via a UI. For example, it can provide a user with a user interface in the form of a UI, present a service to the user through this user interface, and receive various kinds of input from the user. A first app may include many types. For example, a locked-screen app and a search app on a smart mobile terminal are two different types of first apps. Different first apps may be activated in different scenarios. To give an example, a locked-screen app may be activated while the smart mobile terminal is in screen-locked mode. The locked-screen app may trigger a second app for displaying a clock and a second app for displaying weather conditions. Thus, it is possible to present time and weather condition information on the locked-screen app UI. To give another example, a search app may be activated when the user chooses to open the corresponding app (e.g., a browser or other information-searching app). A search input box and search button may be included in the corresponding UI. After the user enters search key words in the search input box, the search app triggers a second app (e.g., a weather app) related to the search key word. In this way, the search app UI may present information relating to the triggered second app (e.g., weather data acquired by the weather app from a network server).

In an embodiment of the present application, the first app manages the second app. For example, the first app will determine when and what kind of second app it will trigger. The first app can also trigger management of the second app life cycle (e.g., creation and destruction). The second app can, on the basis of its own logic, transmit data to the first app for presentation. One first app can trigger one or more second apps.

In order to present data of the triggered second app in the UI of the first app, a visualization area corresponding to the second app is included in the UI of the first app. When one app may trigger multiple second apps, a visualization area is set up in the first app UI for each second app and is used to present the data of the corresponding second app. In cases where a first app may trigger multiple second apps, the visualization areas corresponding to different second apps on the first app UI may differ from each other. Thus, when a first app has triggered multiple second apps, causing them to run, the data of each triggered second app may be presented in different visualization areas of the first UI without resulting in conflict. In another example, the first app may trigger multiple second apps, but simultaneous running of the multiple second apps will not occur. In such a situation, these second apps that will not run simultaneously but may be shared by the same visualization area in the UI of the first app.

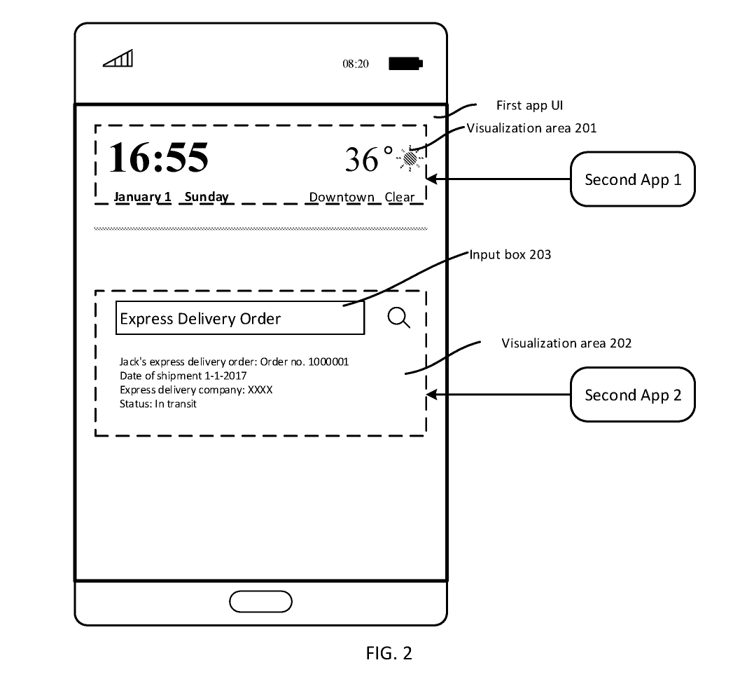

FIG. 2 is a diagram of an example visualization area in a UI of a first app. As shown in FIG. 2, the UI of the first app includes visualization area 201 and visualization area 202. The first app triggers Second App 1 for providing time information and weather conditions and Second App 2 for providing express delivery order information that has been searched and found. The visualization area 201 is configured to display the time information and weather condition data provided by Second App 1, and visualization area 202 is configured to display the express delivery order information that has been searched and found. When the first app is activated, Second App 1 is triggered and executed. The visualization area 201 displays time information and weather condition information provided by Second App 1. After the user enters “express delivery order” in the search input box 203, Second App 2 is triggered and runs. The visualization area 202 displays the express delivery order information provided by Second App 2. Further, the first app UI can also include a visualization area for presenting data of the first app.

In some embodiments of the present application, a second app is configured to include the following component parts:

Display template: used to define the ways and styles in which data is displayed. For example, data acquired by a second app is displayed in the form of text or as an animation. In a further example, in the visualization area of the first app UI, there are the font sizes and colors of the displayed text, the background color of the visualization area, etc. The display template includes a formatted text file in this example. XML, JSON, or other appropriate formats can be used depending on system support. The content of the display template specifies display parameters, such as text position, color, size, etc. The first app can use the template to generate its display according to the specified display style.

Data: second app display content. The data may be provided by the second app or by a server. To give an example of data provided by a second app, the terminal's local clock component can, as a second app, be triggered by the first app and provide time information for the first app and, moreover, present it in the UI of the first app. To give an example of data provided by a server, a second app for providing express delivery order information can use user account and other information to query a network-side server, acquire the corresponding express delivery order information, and provide it to the first app for presentation in the UI of the first app.

Logic: a logic code (or computer code) for defining the logic processing process for a second app. Specifically, it can define the process of generating second app data and interactions with the user. Second app logic can be run on the second app side. The running of some limited computer codes in the first app is also supported.

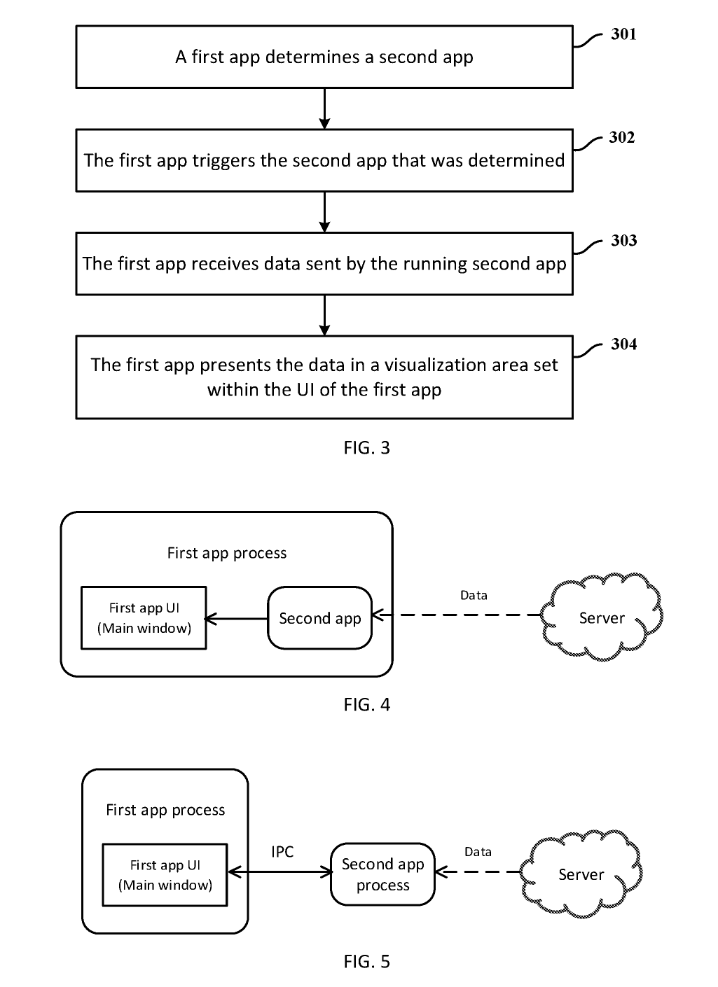

FIG. 3 shows, for the purpose of providing an example, an app use process provided by an embodiment of the present application. FIG. 3 describes a first app triggering a second app and the process of presenting the second app in a first app UI. In 301 shown in FIG. 3, the first app determines the second app. In 302, the first app triggers the second app determined in 301. Applications may have different statuses, also referred to as states. Examples of statuses include activated status (also called created status in some examples), running status (also called refreshed status in some examples), paused status, etc. However, it is generally only while running (i.e., in running status) that it is possible to execute the application's logic, such as acquiring data or interacting with the UI. In step 303, the first app receives data sent by the running second app. In some embodiments, Inter Process Communication (IPC) is used for communicating data between apps. In some systems such as YunOS, APIs that encapsulate the details of IPC are provided and used for transferring data. In 304, the first app presents the data in a visualization area set within the UI of the first app.

To give an example, a first app provides an information searching function. Its UI includes a search key word input box for information searches. After the user enters “weather” in the search key word input box in the UI, the first app determines the second app that matches this key word is the second app that acquires weather condition information. Thus, the first app triggers the second app. The second app uses the IP address of the terminal where the first app is located as a basis for obtaining from a network-side server the weather condition information for the area matching the IP address and sends the acquired weather condition information to the first app. The first app presents the weather condition information in its UI. Through this process, the user does not have to enter the key word “weather,” then click the search button to go to the corresponding page for looking up weather conditions, and then look up weather conditions using this page. The process facilitates user operation and improves user experience.

To give another example, a first app is activated when a sensor (e.g., a capacitive sensor configured to detect capacitance change) in a terminal detects a user's hand reaches for the terminal. The first app triggers Second App 1 and Second App 2, which are for controlling the terminal. Second App 1, on the basis of a system service provided by the operating system, acquires the amount of the terminal's remaining charge and sends the acquired remaining charge information to the first app. Second App 2 sends UI information containing volume-setting and screen brightness-setting function buttons to the first app. The first app makes a presentation in its UI based on the received data. This includes the current remaining charge and the function buttons for setting volume and screen brightness and thus makes it easier for the user to set or control the terminal.

To give another example, when the sensor (e.g., motion sensor, accelerometer, etc.) in the terminal detects that the user is exercising, and the terminal is currently in a locked-screen state, the operating system sends the corresponding event to the locked-screen app (the locked-screen app being a type of first app). In this scenario, the locked-screen app triggers a second app that is for acquiring and displaying physiological parameters or other data pertaining to the user's motion. Thus, the locked-screen app triggers this second app. The second app acquires user physiological parameters and sends them to the first app. The first app presents the acquired user physiological parameters on the locked-screen UI.

Furthermore, in some embodiments, the first app may also use acquired data-updating events as a basis for triggering a second app to reacquire data and present the data that was reacquired by the second app in the UI of the first app.

Furthermore, in some embodiments, the first app may also be able to use a first acquired event that is configured to pause a second app as a basis for triggering a pause in the execution of the second app. Furthermore, it may also be able to use a second acquired event that is for resuming the paused second app (e.g., detecting that the device has stopped moving or has begun moving) as a basis for triggering resumed running of the second app. For example, the first event can be a determination that the device has stopped moving, and the first app pauses the second app to prevent unnecessary consumption of resources. Alternatively, the first event can be a determination that the device has begun moving, and the first app resumes the second app to track the user's motion.

Furthermore, in some embodiments, the first app may also be able to use an acquired event (e.g., stopping and cleaning up) as a basis for destructing the second app. For example, when it is detected that the device has not been moving for a period of time (e.g., five minutes), the first app is notified with this event and will stop and destruct the second app to save system resources.

In some embodiments, the first app may, upon determining that a set condition has been satisfied, determine a second app matching this set condition as in step 301 shown in FIG. 3. Thus, in a self-adaptive actual scenario-based manner, the first app can be configured to trigger a second app that is determined to match the actual scenario given the conditions. The set condition can comprise one or more of the following:

A specified time. Upon reaching the specified time, a first app triggers a second app. For example, every morning at 7:00 AM, the operating system app in a phone triggers an app for acquiring weather condition information and displays the weather condition information in the operating system main UI.

A specified event. When a specific event occurs, a first app triggers a second app. The set event may include but is not limited to: an event generated according to a user operation, e.g., an event generated according to a user operation on the UI of the first app. The set event may further comprise an event generated according to a change in device status of the terminal where the first app is located. For example, the terminal enters locked-screen status, or the terminal enters low-charge status. The set event may further comprise an event that can be generated according to data detected by a sensor in the terminal where the first app is located. An example would be an event generated when the sensor detects someone's hand is near the terminal, as in the example described above.

A specified user behavior. When a specific user behavior occurs, a first app triggers a second app. In one example, the first app is a search app, and the first app triggers a second app when a user performs a search operation using certain keywords on the first app. In this case, when the user enters search key words on the search app UI, the search app acquires the search key words entered on the search app UI and uses the key words as a basis for determining a second app corresponding to the key words. For example, in the example described above, when the user performs an interface operation, such as entering the key words “express delivery order” in the search app UI, the search app can trigger a second app (e.g., a shopping app) that acquires and displays express delivery information. When the user enters the key words “movies” in the search app UI, the search app can trigger a second app (e.g., a movie ticket purchasing app) that displays the movie times at the local theater.

In another example, the first app is a locked-screen app, and the set event is a headphone connection event at the terminal. When headphones are connected to the terminal, the locked-screen app detects the headphone connection event and acquires additional user behavior information. It uses the acquired user behavior information as a basis for determining a second app that corresponds to the acquired user behavior in situations where the headphone connection event occurs. For example, when the headphones are plugged into the headphone receiving port of the terminal or connected to the device via Bluetooth, and the terminal sensor detects that the terminal user is exercising, the first app triggers a music-playing second app based on the user's historical behavior pattern (e.g., historically the user usually plays music while exercising).

The above methods for determining the second app in need of triggering can be used in combination with each other. The examples described above merely list, for the purpose of providing examples, a few possible factors used to determine second apps in need of triggering. The embodiments of the present application are not limited to just these few examples described above.

In some embodiments, the second apps that can be triggered by the first app may be set in advance. For example, second apps that can be triggered by the first app may be set in the form of configuration information or a configuration file. The configuration information or configuration file may include the URIs of second apps that can be triggered by the first app. Of course, it is also possible to define the second apps that can be triggered in the computer code of the first app. For example, the first app computer code specifies that a weather condition-displaying second app be triggered when the terminal screen switches to the operating system main interface. Thus, in 301 of the process described above, the first app may determine the second app that can be triggered based on a setting made in advance.

In embodiments of the present application, the first app can be configured to employ multiple approaches to trigger the second app. Embodiments of the present application define several examples of trigger modes. The way in which the data of the second app is to be displayed in the first app UI and how the second app is to be run (e.g., whether the second app is to be run in the same process with the first app) are defined within the trigger mode. The second app should be executed in a way that does not pose a security threat to the first app. To give an example, embodiments of the present application define the following three trigger modes:

(1) First Trigger Mode, Called the Card Mode

In the card mode, both display and logic of the second app execute in the first app. Specifically, the second app runs in the same process as the first app. Moreover, data of the second app is displayed in the main window in the UI of the first app. In this mode, because the second app runs in the same process as the first app, the second app can potentially access sensitive data in the first app such as account information, password, etc. Thus, the functions of the second app are restricted to ensure the security of the first app. The first app generally only runs security risk-free functions (methods). Therefore, the second app that is running in the same process as the first app may use resources of the first app to perform the logic of the second app (e.g., the logic of acquiring data) and thus ensure the security of the apps. In addition, the display template used by the data of the second app is generated by the description file. Therefore, second app data is displayed in a way that can use controls and animation effects supported by this description file.

As for the card mode, data display is generated according to the description file of the card specification. The JavaScript code that can be executed only includes some security risk-free functions. Therefore, it will not cause the first app to have security loopholes. In addition, in the card mode, the logic of the second app runs in the first app without requiring inter-process communication (IPC). Data can be exchanged between the first app and the second app via shared memory, objects, data structures, etc. Display operations are also run in the first app. There is no extra resource consumption. Therefore, the card mode has relatively good performance.

FIG. 4 shows an example diagram of the card mode. The second app runs in the process where the first app is located, uses the same resources as the first app, and shares the same run environment. The second app data is displayed in the main window of the first app.

(2) Second Trigger Mode (or Widget Mode)

In the Widget mode, the second app data is displayed in the main window of the first app UI, and the logic runs in an independent process. Specifically, the second app runs in a different process from the first app. However, data of the second app is displayed in the main window in the UI of the first app. The second app runs in a different process from the first app and can use resources other than the resources used by the first app process. As a result, the running of the second app can be made more flexible, with more powerful logic processing functions. For example, the second app may acquire data from the server. In addition, the display template used by the data of the second app is generated by a text file (e.g., an XML file, a JSON file, etc.). Therefore, second app data is displayed in a way that can use the description file to support controls and animation effects.

As for the Widget mode, executable JavaScript code is not subject to first app restrictions; complete JavaScript capabilities can be realized. The logic is run entirely in an independent second app process. The first app does not run any second app logic code. Therefore, there is little security risk posed by the second app to the first app.

FIG. 5 shows, for the purpose of providing an example, a diagram of the Widget mode. The second app runs in a different process from the first app, and data of the second app is displayed in the main window of the first app.

(3) Third Trigger Mode (or the Super Widget Mode)

In the super Widget mode, the second app is displayed in a sub-window of the first app (that is, in a window other than the main window of the first app's UI). The sub-window belongs to the main window (and thus co-exists with the main window), but has its own render buffer. The display template used by the sub-window need not be generated from the description file. For example, the display template may be set according to the necessary display effects; the logic runs in an independent process. Specifically, the second app runs in a different process from the first app. Moreover, data of the second app is displayed in a sub-window in the UI of the first app. The second app runs in a different process from the first app and can use resources other than the resources used by the first app process. As a result, it can avoid first app restrictions, making the running of the second app more flexible, with more powerful logic processing functions. For example, the second app may acquire data from a server. In addition, the display of the second app data is completely controlled by the second app process. Therefore, it can support all controls and animation effects, resulting in greater flexibility as to forms of second app display.

As for the super Widget mode, executable JavaScript code is not subject to first app restrictions; complete JavaScript capabilities can be realized. The logic is run entirely in an independent second app process. The first app does not run any second app logic code. Therefore, there is little security risk posed to the first app. As for display capabilities, the super Widget mode supports all control types.

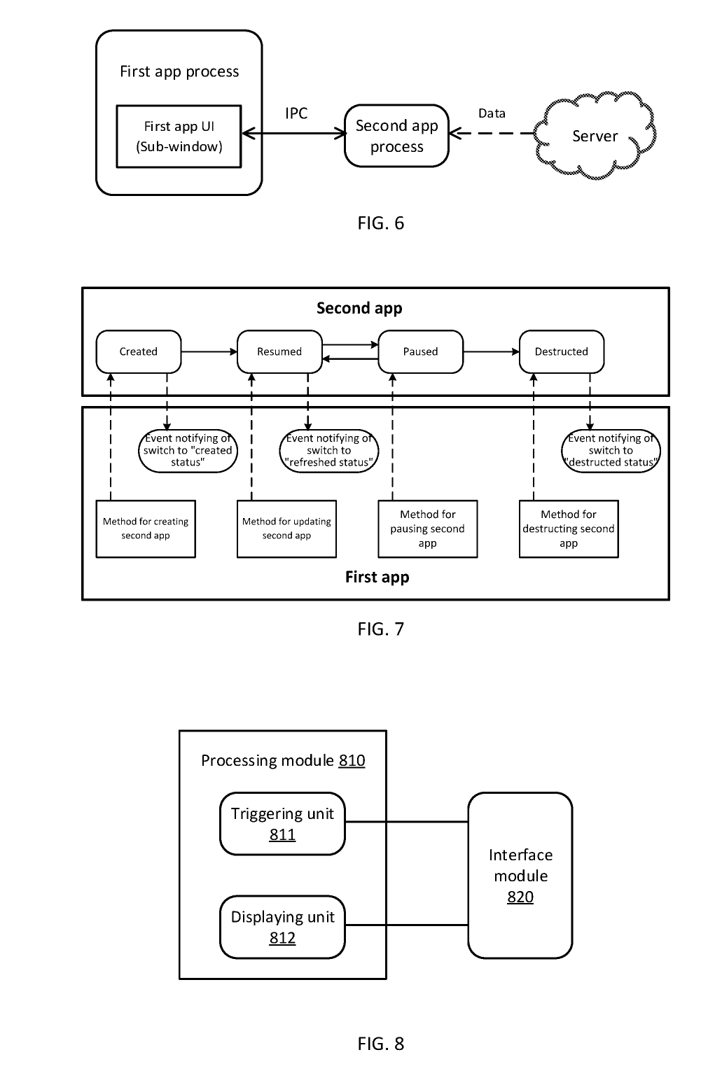

FIG. 6 shows an example diagram of the super Widget mode. The second app runs in a different process from the first app, and data of the second app is displayed in a sub-window of the first app.

A comparison of the various trigger methods can reveal that the trigger results described above differ as to security, display, logic capability, performance, and resource expenditure. To trigger and run a second app, the first app may select one of the trigger methods described above according to actual need. During specific implementation, the first app can determine the trigger method for the second app before triggering the second app, and then trigger the second app according to this trigger method. Specifically, the first app can determine the trigger mode of the second app according to one or any combination of the following:

Preset trigger mode: the trigger mode for the second app may be set in advance. Thus, the first app may trigger the second app according to a preset trigger mode. During specific implementation, trigger modes may be preset for some types of second apps.

Second app-supported trigger mode: the first app can trigger a second app according to the trigger mode supported by the second app. The triggering capabilities supported by different second apps differ. Thus, the first app may employ a trigger mode adapted to the second app's capability to trigger the second app. If the second app supports multiple trigger modes, a strategy may be established in advance for selecting the trigger mode. For example, it may be selected according to the principle of least resource expenditure.

The logic capability required by the second app: the first app can determine the second app trigger mode according to the logic capability required by the second app. For example, if it is necessary to acquire data from a network-side server, then the Widget mode or super Widget mode may be employed.

The display effects required by the second app data: the first app can determine the second app trigger mode according to the display effects required by the second app data. For example, if there are higher requirements for display effects (a richer form of display), then the super Widget mode may be employed.

The display resources expenditure requirement of the second app data: the first app can determine the second app trigger method according to the display resource expenditure requirement of the second app data. For example, if there is a smaller display resource expenditure requirement, then the card mode may be employed.

Given the above-described bases for determining trigger modes, the first app may acquire information on the capabilities supported by the second app before triggering the second app. For example, the capabilities of the second app can be stored in the app description metadata, which is recorded by the system when the app is installed. The first app can obtain the description metadata from the system using certain query APIs. Then the first app will select the trigger mode based on the actual situation.

### EXAMPLE 1

Second App A supports the card mode and the Widget mode. The first app needs to simultaneously trigger multiple second apps, including Second App A. For performance-related reasons, the first app uses the card mode to trigger Second App A.

### EXAMPLE 2

Second App B supports the Widget mode and super Widget mode. The first app, triggered by a specific event, needs to trigger Second App B. For display effect-related reasons, the first app uses the super Widget mode to trigger Second App B.

### EXAMPLE 3

Second App C supports only the super Widget mode, yet the mode expected by the first app is the card mode. Under these circumstances, the first app refuses to trigger Second App C.

As stated above, the first app can trigger management over the second app life cycle. FIG. 7 shows, for the purpose of providing an example, a diagram of each status and the transitions between statuses in the second app life cycle. As shown in the figure, the second app life cycle includes: created status, refreshed (resumed) status, paused status, and destructed status. Second app status transition may be triggered by the first app. The second app may notify the first app of the status transition result via an event.

Created status: the first app may create an instance of the second app by calling a method for creating an app Cover. Optionally, if the creation is successful, the second app will automatically jump to the refreshed (resumed) status and notify the first app of the current status via an event. During specific implementation, the first app may, after receiving an event for triggering a second app, call a method for creating a second app to create an instance of the second app. For example, when the user enters “express delivery order” in the search box in a search app UI, the operating system generates the corresponding event and sends it to the search app. The search app uses the event as a basis for creating a second app used to acquire and display express delivery order information.

Refreshed (resumed) status: this is the normal operating status of a second app. The first app may trigger the second app to jump to the refreshed (resumed) status by calling the update method of the second app. The second app may also jump to the refreshed (resumed) status after the second app is successfully created. During specific implementation, the first app may periodically call the update method to trigger a second app to jump to refreshed (resumed) status. The first app may also, upon receiving an event that is for refreshing data, call the update method to trigger the second app to jump to refreshed (resumed) status. In another example, a second app in refreshed (resumed) status may also be refreshed according to its own logic and send the refresh event and the data obtained by refreshing to the first app in order to trigger the first app to refresh the second app data in its UI.

Paused status: this takes the form of a cessation in display refreshing and logic processing. The first app may trigger a second app to jump to the paused status by calling the pause method of the second app. A second app in paused status may also jump to another status, e.g., jump to refreshed (resumed) status, as a result of the first app calling the resume paused method. During specific implementation, the first app may, while executing the operation of hiding the UI, call the pause method to trigger the second app to jump to paused status.

Destructed status: the first app may trigger a second app to jump to destructed status by calling the destruct method. In specific implementations, the first app may, after the second app's logic is executed, trigger a second app to jump to destructed status by calling the destruct method.

In embodiments of the present application, the first app may trigger a second app in order to cause the second app data to be presented in the first app UI. Furthermore, the first app may self-adaptively determine the second app that needs to be triggered so that the triggered second app matches the actual scenario in which the second app is triggered.

The second app running entity in each of the embodiments described above may be an app. Other types of app access may be supported for other operating systems such as iOS® or Android®. So long as implementation is in accordance with the second app life cycle and interface specifications, the data of the triggered second app may be displayed in the first app UI.

Embodiments of the present application further provide a means for running apps that is based on the same technical concepts. Refer to FIG. 8, which is a structural diagram of an app running means provided by an embodiment of the present application. The means is for implementing functions of a first app. The means may comprise a processing module 810 and an interface module 820, wherein the processing module 810 comprises a triggering unit 811 and a displaying unit 812.

The triggering unit 811 is configured to trigger a second app. The interface module 820 is configured to receive data sent by the second app while it is running. The displaying unit 812 is configured to present the data in a visualization area set within the user interface of the first app.

Optionally, the triggering unit 811 is specifically configured to: upon determining that a set condition has been met, determine a second app matched with the set condition, and trigger the second app.

Optionally, the set condition may comprise: a set time has been reached, a set event has occurred, a set user behavior, or a combination thereof.

Optionally, the set condition comprises: an event generated according to a user operation, an event generated according to a change in the device status of the terminal where the first app is located, an event generated according to data detected by a sensor in the terminal where the first app is located, or a combination thereof.

Optionally, the set event generated according to a user operation comprises: an event generated according to a user operation on the user interface of the first app.

Optionally, the triggering unit 811 is specifically configured to: determine the trigger mode of the second app and use the determined trigger mode as a basis for triggering the second app.

Optionally, the trigger modes comprise: a first trigger mode under which the second app and the first app execute in the same process, and the data is presented in the main window of the first app; a second trigger mode under which the second app and the first app execute in different processes, and the data is presented in the main window of the first app; a third trigger mode under which the second app and the first app execute in different processes, and the data is presented in a sub-window of the first app.

Optionally, there are one or more second apps. If the number of the second app is more than one, a separate visualization area is set up within the interface of the first app for each second app, with each visualization area presenting the data acquired by the corresponding second app.

Optionally, visualization areas corresponding to different second apps differ from one another. Alternatively, visualization areas corresponding to non-simultaneously running second apps are the same.

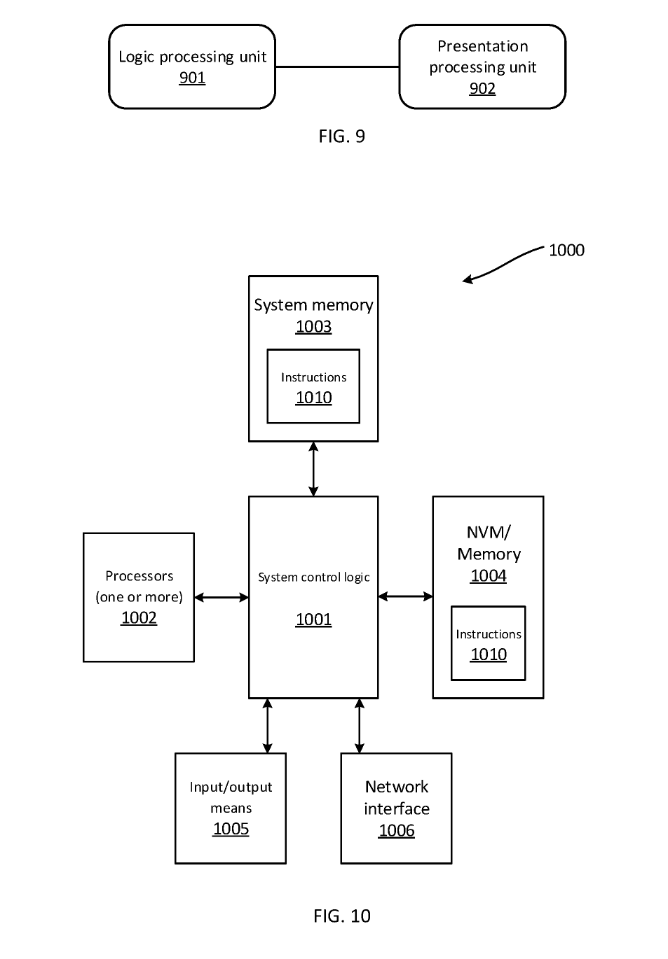

Embodiments of the present application further provide a means for running apps that is based on the same technical concepts. Refer to FIG. 9, which is a structural diagram of an app running means provided by an embodiment of the present application. The first app provides a user interface. The user interface comprises a first visualization area and a second visualization area. The first visualization area is for displaying data of the first app. The means is for implementing first app functions. The means comprises: a logic processing unit 901 and a presentation processing unit 902.

The logic processing unit 901 is configured to trigger a second app and to receive data sent by the second app while the second app is running. The presentation processing unit 902 is configured to refresh the user interface of the first app. The data of the second app is presented in the second visualization area of the user interface.

Optionally, the logic processing unit 901 is specifically configured to: upon determining that a set condition has been met, determine a second app matched with the set condition, and trigger the second app.

Optionally, the set condition may comprise: a set time has been reached; a set event has occurred; a set user behavior, or a combination thereof.

Optionally, the logic processing unit 901 is specifically configured to determine the trigger mode of the second app and use the determined trigger mode as a basis for triggering the second app. The trigger modes comprise: a first trigger mode under which the second app and the first app execute in the same process, and the data is presented in the main window of the first app; a second trigger mode under which the second app and the first app run in different processes, and the data is presented in the main window of the first app; a third trigger mode under which the second app and the first app execute in different processes, and the data is presented in a sub-window of the first app.

Optionally, second visualization areas corresponding to different second apps differ from one another. Alternatively, visualization areas corresponding to non-simultaneously running second apps are the same.

Embodiments of the present application further provide a communication device 1000 that is based on the same technical concepts. The device 1000 may implement the process described in the above embodiments. FIG. 10 shows, for the purpose of providing an example, an example device 1000 according to various embodiments. The device 1000 may comprise one or more processors 1002, a system control logic 1001 coupled to at least one processor 1002, non-volatile memory (NMV)/memory 1004 coupled to the system control logic 1001, and a network interface 1006 coupled to the system control logic 1001.

The processor 1002 may comprise one or more single-core processors or multi-core processors. The processor 1002 may comprise any combination of general-purpose processors or special-purpose processors (such as image processors, app processors, and baseband processors).

The system control logic 1001 in this embodiment comprises an appropriate interface controller to provide any suitable interface to at least one of the processors 1002 and/or to provide any suitable interface to any suitable device or component communicating with the system control logic 1001.

The system control logic 1001 in this embodiment comprises one or more memory controllers so as to provide interfaces to the system memory 1003. The system memory 1003 is configured for triggering and storing data and/or instructions. For example, corresponding to the means 1000, the system memory 1003 in an embodiment may comprise any suitable volatile memory.

The NVM/memory 1004 comprises one or more physical, non-temporary, computer-readable media for storing data and/or instructions. For example, the NVM/memory 1004 may comprise any suitable non-volatile memory means, such as one or more hard disk devices (HDD), one or more compact disks (CD), and/or one or more digital versatile disks (DVD).

The NVM/memory 1004 may comprise storage resources. These storage resources are physically part of a device that is installed on the system or that can be accessed, but they are not necessarily a part of the device. For example, the NVM/memory 1004 may be accessed by a network via the network interface 1006.

The system memory 1003 and the NVM/memory 1004 may each include temporary or permanent copies of instructions 1010. The instructions 1010 may include instructions that, when executed by at least one of the processors 1002, cause one or a combination of the methods described in FIGS. 2 through 7 to be implemented by device 1000. In each embodiment, the instructions 1010 or hardware, firmware, and/or software components may additionally/alternately be put within the system control logic 1001, network interface 1006, and/or processors 1002.

The network interface 1006 may include a receiver to provide the means 1000 with a wireless interface for communication with one or more networks and/or any suitable device. The network interface 1006 may include any suitable hardware and/or firmware. The network interface 1006 may include multiple antennae to provide multi-input/multi-output wireless interfaces. In an embodiment, the network interface 1006 may comprise a network adapter, a wireless network adapter, a telephone modem, and/or a wireless modem.

In this embodiment, at least one of the processors 1002 may be packaged together with the logic of one or more controllers of the system control logic. In an embodiment, at least one of the processors may be packaged together with one or more controllers of the system control logic to form a system-level package. In an embodiment, at least one of the processors may be integrated together with the logic of one or more controllers of the system control logic in the same chip. In an embodiment, at least one of the processors may be integrated together with the logic of one or more controllers of the system control logic in the same chip to form a system chip.

The device 1000 may further comprise an input/output means 1005. The input/output means 1005 may comprise a user interface that is for causing interaction between the user and the means 1000. It may comprise a peripheral component interface, which is designed to enable peripheral components to interact with the system, and/or it may comprise sensors for determining environmental conditions and/or location information relating to the means 1000.

Embodiments of the present application further provide a communication means comprising: one or more processors and one or more computer-readable media. The readable media stores instructions. When the instructions are executed by the one or more processors, the communication means is caused to execute the methods as described in the embodiments described above.

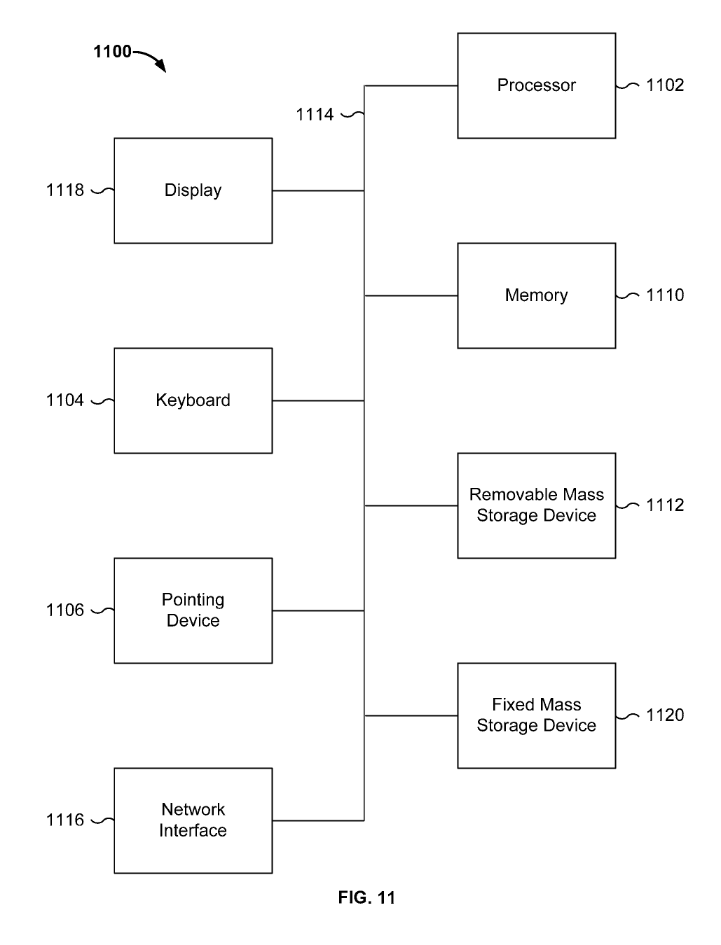

FIG. 11 is a functional diagram illustrating a programmed computer system for displaying app information in accordance with some embodiments. As will be apparent, other computer system architectures and configurations can be used to perform the described app information displaying technique. Computer system 1100 can be a mobile device. Computer system 1100 includes various subsystems as described below, and includes at least one microprocessor subsystem (also referred to as a processor or a central processing unit (CPU) 1102). For example, processor 1102 can be implemented by a single-chip processor or by multiple processors. In some embodiments, processor 1102 is a general purpose digital processor that controls the operation of the computer system 1100. In some embodiments, processor 1102 also includes one or more coprocessors or special purpose processors (e.g., a graphics processor, a network processor, etc.). Using instructions retrieved from memory 1110, processor 1102 controls the reception and manipulation of input data received on an input device (e.g., image processing device 1106, I/O device interface 1104), and the output and display of data on output devices (e.g., display 1118).

Processor 1102 is coupled bi-directionally with memory 1110, which can include, for example, one or more random access memories (RAM) and/or one or more read-only memories (ROM). As is well known in the art, memory 1110 can be used as a general storage area, a temporary (e.g., scratch pad) memory, and/or a cache memory. Memory 1110 can also be used to store input data and processed data, as well as to store programming instructions and data, in the form of data objects and text objects, in addition to other data and instructions for processes operating on processor 1102. Also as is well known in the art, memory 1110 typically includes basic operating instructions, program code, data, and objects used by the processor 1102 to perform its functions (e.g., programmed instructions). For example, memory 1110 can include any suitable computer readable storage media described below, depending on whether, for example, data access needs to be bi-directional or uni-directional. For example, processor 1102 can also directly and very rapidly retrieve and store frequently needed data in a cache memory included in memory 1110.

A removable mass storage device 1112 provides additional data storage capacity for the computer system 1100, and is optionally coupled either bi-directionally (read/write) or uni-directionally (read only) to processor 1102. A fixed mass storage 1120 can also, for example, provide additional data storage capacity. For example, storage devices 1112 and/or 1120 can include computer readable media such as magnetic tape, flash memory, PC-CARDS, portable mass storage devices such as hard drives (e.g., magnetic, optical, or solid state drives), holographic storage devices, and other storage devices. Mass storages 1112 and/or 1120 generally store additional programming instructions, data, and the like that typically are not in active use by the processor 1102. It will be appreciated that the information retained within mass storages 1112 and 1120 can be incorporated, if needed, in standard fashion as part of memory 1110 (e.g., RAM) as virtual memory.

In addition to providing processor 1102 access to storage subsystems, bus 1114 can be used to provide access to other subsystems and devices as well. As shown, these can include a display 1118, a network interface 1116, an input/output (I/O) device interface 1104, an image processing device 1106, as well as other subsystems and devices. For example, image processing device 1106 can include a camera, a scanner, etc.; I/O device interface 1104 can include a device interface for interacting with a touchscreen (e.g., a capacitive touch sensitive screen that supports gesture interpretation), a microphone, a sound card, a speaker, a keyboard, a pointing device (e.g., a mouse, a stylus, a human finger), a Global Positioning System (GPS) receiver, an accelerometer, and/or any other appropriate device interface for interacting with system 1100. Multiple I/O device interfaces can be used in conjunction with computer system 1100. The I/O device interface can include general and customized interfaces that allow the processor 1102 to send and, more typically, receive data from other devices such as keyboards, pointing devices, microphones, touchscreens, transducer card readers, tape readers, voice or handwriting recognizers, biometrics readers, cameras, portable mass storage devices, and other computers.

The network interface 1116 allows processor 1102 to be coupled to another computer, computer network, or telecommunications network using a network connection as shown. For example, through the network interface 1116, the processor 1102 can receive information (e.g., data objects or program instructions) from another network, or output information to another network in the course of performing method/process steps. Information, often represented as a sequence of instructions to be executed on a processor, can be received from and outputted to another network. An interface card or similar device and appropriate software implemented by (e.g., executed/performed on) processor 1102 can be used to connect the computer system 1100 to an external network and transfer data according to standard protocols. For example, various process embodiments disclosed herein can be executed on processor 1102, or can be performed across a network such as the Internet, intranet networks, or local area networks, in conjunction with a remote processor that shares a portion of the processing. Additional mass storage devices (not shown) can also be connected to processor 1102 through network interface 1116.

In addition, various embodiments disclosed herein further relate to computer storage products with a computer readable medium that includes program code for performing various computer-implemented operations. The computer readable medium includes any data storage device that can store data which can thereafter be read by a computer system. Examples of computer readable media include, but are not limited to: magnetic media such as disks and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code as produced, for example, by a compiler, or files containing higher level code (e.g., script) that can be executed using an interpreter.

The computer system shown in FIG. 11 is but an example of a computer system suitable for use with the various embodiments disclosed herein. Other computer systems suitable for such use can include additional or fewer subsystems. In some computer systems, subsystems can share components (e.g., for touchscreen-based devices such as smart phones, tablets, etc., I/O device interface 1104 and display 1118 share the touch sensitive screen component, which both detects user inputs and displays outputs to the user). In addition, bus 1114 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
executing a first application;
using the first application to trigger a second application to execute;
transferring data from the second application to the first application; and
presenting the data that is transferred from the second application in a visualization area within a user interface display area of the first application.

2. The method of claim 1, wherein the using of the first application to trigger the second application comprises determining that the second application matches a set of one or more conditions.

3. The method of claim 1, wherein:
the using of the first application to trigger the second application comprises determining that the second application matches a set of one or more conditions; and
the set of one or more conditions pertains to at least one of:
is a specified time;
a specified event; and
a specified user behavior.

4. The method of claim 1, wherein:
the using of the first application to trigger the second application comprises determining that the second application matches at least a specified event; and
the specified event comprises one or more of:
an event generated according to a user operation;
an event generated according to a change in a device status of a terminal where the first application is located; and
an event generated according to data detected by a sensor in the terminal where the first application is located.

5. The method of claim 1, wherein:
the using of the first application to trigger the second application comprises determining that the second application matches at least a specified event; and
the specified event is generated according to a user operation performed via the first application.

6. The method of claim 1, wherein:
the using of the first application to trigger the second application comprises determining that the second application matches at least a specified event;
the specified event is generated according to a user operation performed via the first application, wherein the first application is a search application, and the user operation comprises entering a search keyword on the user interface display area of the first application; and
the determination that the second application matches at least the specified event comprises:
acquiring a set of one or more search key words entered via a user interface of the search application; and
determining the second application that corresponds to the set of one or more search key words, based at least in part on the set of one or more search key words.

7. The method of claim 1, wherein:
the using of the first application to trigger the second application comprises determining that the second application matches at least a specified event;
the first application is a locked-screen application;
the specified event is a headphone insertion event; and
the determining that the second application matching at least the specified event comprises:
upon detecting the headphone insertion event, acquiring user behavior information; and
determining the second application that corresponds to the user behavior information, based at least in part on the user behavior information.

8. The method of claim 1, wherein the using of the first application to trigger the second application comprises:
determining a trigger mode for the second application; and
triggering the second application according to the trigger mode.

9. The method of claim 8, wherein under the trigger mode:
the second application and the first application execute in a same process; and
the data is presented in a main window of the first application.

10. The method of claim 8, wherein under the trigger mode:
the second application and the first application execute in different processes; and
the data is presented in a main window of the first application.

11. The method of claim 8, wherein under the trigger mode:
the second application and the first application execute in different processes; and
the data is presented in a sub-window of the first application.

12. The method of claim 8, wherein the first application determines the trigger mode of the second application according to one or more of:
a preset trigger mode;
a trigger mode supported by the second application;
a logic capability required by the second application;
a display effect required by data of the second application; and
is a display resource expenditure requirement for data of the second application.

13. The method of claim 1, further comprising:
acquiring a first event;
in response to the first event, causing the second application to be paused, using the first application;
acquiring a second event; and
in response to the second event, causing the second application to resume execution.

14. The method of claim 1, further comprising:
in response to acquiring an event, destructing the second application.

15. The method of claim 1, wherein:
the second application is one of a plurality of applications that are triggered by the first application; and
the visualization area is one of a plurality of visualization areas that are configured, within the user interface display area of the first application, to present data acquired by corresponding ones of the plurality of the applications that are triggered by the first application.

16. The method of claim 1, wherein the first application comprises one of the following types of applications: a system application, a downloadable and installable application, a foreground application, a background service, or a component; and
the second application comprises one of the following types of applications: a system application, a downloadable and installable application, a foreground application, a background service, a component.

17. The method of claim 1, wherein the first application and the second application are service components running in a cloud operating system.

18. The method of claim 1, wherein using the first application to trigger the second application comprises:
determining a second service component based at least in part on a uniform resource locator (URL) of the second service component; and
triggering the second service component.

19. A system, comprising:
is one or more processors configured to:
execute a first application;
use the first application to trigger a second application to execute;
transfer data from the second application to the first application; and
present the data that is transferred from the second application in a visualization area within a user interface display area of the first application; and
one or more memories coupled to the one or more processors, configured to provide the one or more processors with instructions.

20. A computer program product embodied in a tangible non-transitory computer readable storage medium and comprising computer instructions for:
executing a first application;
using the first application to trigger a second application to execute;
transferring data from the second application to the first application; and
presenting the data that is transferred from the second application in a visualization area within a user interface display area of the first application.
